(19) United States
(12) Patent Application Publication
(10) Pub. No.: US 2018/0144744 A1
(43) Pub. Date: May 24, 2018

(54) CONTROLLING A USER INTERFACE CONSOLE USING SPEECH RECOGNITION

(71) Applicant: salesforce.com, inc., San Francisco, CA (US)

(72) Inventors: Adarsha Badarinath, Foster City, CA (US); George Hu, San Francisco, CA (US); Gautam Vasudev, San Francisco, CA (US)

(21) Appl. No.: 15/359,443

(22) Filed: Nov. 22, 2016

(51) Int. Cl. G10L 15/22; G10L 15/16; G10L 15/18; G10L 15/30

(52) U.S. Cl. CPC G10L 15/22; G10L 15/16; G10L 2015/223; G10L 15/30; G10L 15/1822

(57) ABSTRACT

Disclosed are examples of systems, apparatus, methods, and computer program products for controlling a user interface console using speech recognition. In some implementations, user interface consoles and speech commands are maintained. A presentation of a user interface console can be displayed at a user device. Audio data received from the user device can be processed. Speech items based on the audio data can be generated. It can be determined that a first speech item matches a first speech command. It can be determined that a second speech item matches a second speech command. A third speech item can be identified as being associated with a user-customized component. An updated presentation of a user interface console can be displayed based on the first speech command and the second speech command.

### COPYRIGHT NOTICE

A portion of the disclosure of this patent document contains material that is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### TECHNICAL FIELD

This patent document generally relates to a user interface console of a distributed database system. More specifically, this patent document discloses techniques for controlling a user interface console using speech recognition.

### BACKGROUND

“Cloud computing” services provide shared resources, applications, and information to computers and other devices upon request. In cloud computing environments, services can be provided by one or more servers accessible over the Internet rather than installing software locally on in-house computer systems. As such, users having a variety of roles can interact with cloud computing services.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1 shows a system diagram of an example of a system 100 for controlling a user interface console using speech recognition, in accordance with some implementations.

FIG. 2 shows a flow chart of an example of a method 200 for controlling a user interface console using speech recognition, in accordance with some implementations.

FIG. 3 shows an example of a user interface console 304 displayed on a user device 300, in accordance with some implementations.

FIG. 4 shows an example of an updated presentation of a user interface console 400, in accordance with some implementations.

FIG. 5 shows an example of a component displayed on a computing device, in accordance with some implementations.

FIG. 6 shows an example of generating speech commands based on audio data, in accordance with some implementations.

FIG. 7A shows a block diagram of an example of an environment 10 in which an on-demand database service can be used in accordance with some implementations.

FIG. 7B shows a block diagram of an example of some implementations of elements of FIG. 7A and various possible interconnections between these elements.

FIG. 8A shows a system diagram of an example of architectural components of an on-demand database service environment 900, in accordance with some implementations.

FIG. 8B shows a system diagram further illustrating an example of architectural components of an on-demand database service environment, in accordance with some implementations.

### DETAILED DESCRIPTION

Examples of systems, apparatus, methods and computer-readable storage media according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some of the disclosed implementations of systems, apparatus, methods and computer program products are configured for controlling a user interface console using speech recognition.

By way of example, the San Francisco Municipal Railway (SF Muni) uses a conventional enterprise computing environment to handle its customer support. Reza is a customer support agent at SF Muni. He is responsible for handling customer concerns regarding the cable car system in San Francisco. Reza typically handles hundreds of calls each day using a headset, a microphone, and multiple monitors at his desk. For each call that Reza handles, he logs the details of the conversation using the enterprise computing environment. For each call he logs, he directs his mouse cursor to many different parts of the user interface shared across multiple monitors and browser windows. After navigating to these different parts of the user interface, he performs several mouse clicks and types in information relating to the call. The information he might log includes the name of the customer and a summary of the conversation. As such, the process of logging a call can take 15 seconds or more. Over the course of the day if Reza handles approximately 250 calls, he spends roughly an hour navigating within his user interface to input information.

In an alternative scenario to the one discussed above, SF Muni uses a system implementing some of the disclosed techniques to control a user interface console using speech recognition. Instead of using a mouse and keyboard to log phone call information, Reza speaks into the microphone to log his call. For example, Reza might speak into the microphone saying, “OK console. Open a new tab and log a call. Name Heather Smith. Details Cable Car rolled over her purse.” In response to receiving the voice data from Reza's computer, a server in the system can process his voice data and automatically cause a new console tab to be opened in Reza's user interface console. The new tab can include a call logging component with fields that are populated with text based on the processed voice data, e.g., a name field populated with “Heather Smith” and a details field populated with “Cable Car rolled over her purse.” This process could take approximately 5 seconds compared to the 30 seconds it might take Reza to manually input this information. Consequently, Reza can spend significantly more time handling additional calls. In some implementations, a user can control a user interface console using customized speech commands to further improve productivity. For instance, returning to the example of the preceding paragraph, Reza might speak into the microphone saying, “OK console. Add Heather Smith to the SF Muni call logger.” The SF Muni call logger might be a custom component created by an administrator. In addition, the command “Add [x customer]” can be a custom speech command for controlling the SF Muni call logger component. The SF Muni call logger can be configured to automatically maintain a schedule for following up with customer complaints. By “adding” Heather Smith to the SF Muni call logger, Reza does not need to manually enter reminder information for Heather Smith, and as such Reza can shift his attention to new customer concerns more quickly.

In other implementations, returning to the example above, an administrator can customize the above process for Reza's organization by using application programming interface (API) requests. For example, SF muni might introduce a new ticketing system external to their enterprise computing environment. Using some of the disclosed techniques, the ticketing system can be integrated into a multi-monitor user interface console through the use an API. For example, Reza might say “OK console, add the new ticketing plan to the caller.” By using a sequence of API requests, the enterprise computing environment can communicate with external systems to identify the “new ticketing plan,” allowing the enterprise computing environment to combine the functionality of the new ticketing plan with data associated with “the caller,” stored internally at the enterprise computing environment.

These and other implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

In some but not all implementations, the disclosed methods, apparatus, systems, and computer-readable storage media may be configured or designed for use in a multi-tenant database environment.

The term “multi-tenant database system” can refer to those systems in which various elements of hardware and software of a database system may be shared by one or more customers. For example, a given application server may simultaneously process requests for a great number of customers, and a given database table may store rows of data such as feed items for a potentially much greater number of customers. The term “query plan” generally refers to one or more operations used to access information in a database system.

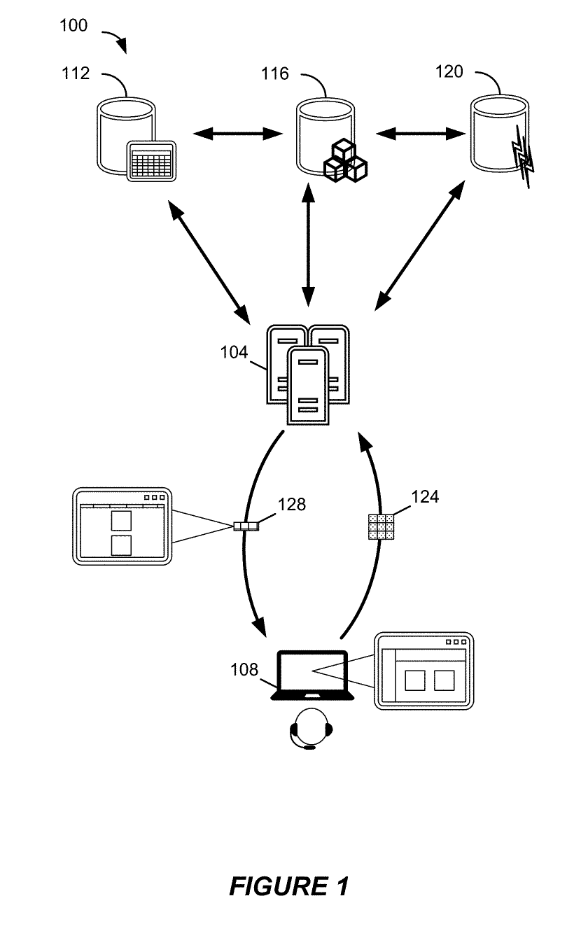

FIG. 1 shows a system diagram of an example of a system 100 for controlling a user interface console using speech recognition, in accordance with some implementations. System 100 includes a variety of different hardware and/or software components which are in communication with each other. In the non-limiting example of FIG. 1, system 100 includes at least one server 104, at least one record database 112, at least one component database 116, and speech command database 120.

In FIG. 1, server 104 may communicate with other components of system 100. This communication may be facilitated through a combination of networks and interfaces. Server 104 and/or user device 108 can maintain components for user interface consoles stored in component database 116. Server 104 and/ or user device 108 can also maintain speech commands stored in speech commands database 120.

Also or alternatively, speech commands can be maintained at user device 108. For example, server 104 can create new user interface consoles; update and/or change an existing user interface console, e.g., through user customization of components; and delete an existing user interface console. Server 104 and/or user device 108 can also maintain speech commands stored in speech command database 120. For example, server 104 can create new speech commands, e.g., user-customized commands; update and/or change an existing speech command; and delete an existing speech command. In addition, server 104 may receive and process data requests from a user device 108. In some implementations, caching of an action at user device 108 can allow offline functionality without additional interaction with server 104. As such an agent using user device 108 can perform actions without an internet connection. In addition, user device 108 can send audio data 124, e.g., a user communication generated from an audio input device. Upon receiving audio data 124, server 104 might begin processing the received audio data 124 by converting audio data 124 to an unstructured text data object. In one example, if internet connectivity is lost, previous knowledge of actions that have been cached at user device 108 can be used to control the user interface console using speech recognition. Parsing data from parsing the unstructured text data object can be stored in a different data object representing speech recognition data. Also or alternatively, server 104 may respond to requests from user device 108 and/or databases 112, 116, and 120. For example, server 104 can send an updated presentation of user interface console 128 to user device 108.

In some implementations, server 104 responds to a request from user device 108 for data stored in record database 112, for instance a request to display an opportunity record using a highlights component. As part of receiving and processing requests, server 104 tracks and maintains metadata regarding requests received, e.g., request identifier, timestamp, user device identifier, etc. In other implementations, server 104 may retrieve data from databases 112, 116, and 120, combine some or all of the data from those databases, and send the combined data to user device 108 as a single HTTP response from server 104.

In FIG. 1, record database 112 can be configured to receive, transmit, store, update, and otherwise maintain record data stored in record database 112. In some implementations, record database 112 can store customer relationship management (CRM) records. Examples of CRM records include instances of accounts, opportunities, leads, cases, contacts, contracts, campaigns, solutions, quotes, purchase orders, etc. Different portions of a CRM record can be displayed according to a type component, e.g., a details component can display a large portion of the content of a CRM record, whereas a highlights component can display a smaller portion of the CRM record. In some implementations, records of enterprise record database 112 are sent to user device 108 and stored in a user device cache.

In FIG. 1, component database 116 can be configured using server 104 to receive, transmit, store, update, and otherwise maintain user interface consoles and/or component data stored in component database 116 at system 100 and/or user device 108. In some implementations, component database 116 may include a variety of components. Components may represent self-contained and reusable portions of a user interface, which can be configured for a particular business purpose, e.g., taking notes or checking the status of a pending sale. Also or alternatively, components can vary in complexity. For example, simple examples can include a button, a text field, a date picker, or a checkbox, while more complex examples can include combinations of the simple examples, a highlights component or a details component. A component may range in granularity from a single line of text to an entire application. Also or alternatively, components may be customized according to customer needs, e.g., SF Muni call logger discussed above. Components can be configured using fields to provide detailed information from a record. For example, a highlight component may provide data corresponding to a name field of an account record, e.g., “SF Muni,” and a phone number field, e.g., “(555)555-5555.” Also or alternatively, a variety of different components can be displayed as part of the same user interface console, for instance, a highlights component, a notes component, and a custom component. In some implementations, a user interface console can allow a customer service representative to monitor and respond through a variety of customer channels from one screen using a combination of tabs and sub tabs. Additionally, a user interface console may be a combination of many components that provide help desk functionality to assist customer service representatives in particular aspects of their job, for instance, an interaction log panel, which shows the history of past communications with a customer. In some implementations, a user interface console includes navigation tabs for selecting CRM records, a primary tab for displaying a main item of a selected CRM record, e.g., a case being worked on, and subtabs displaying items related to the primary tab, e.g., a contact for a case. In some implementations, support is provided for interaction with multiple monitors, browsers, and/or browser windows.

In FIG. 1, similar to databases 112 and 116, speech command database 120 can be configured to receive, store, update, and otherwise maintain speech commands stored in speech command database 120. Also or alternatively, speech commands can be synchronized between system 100 and user device 108. In some implementations, speech commands include commands that correspond to standard actions using an API, e.g., closetab(), opentab(), sendmessage(), etc. In some implantations, API requests are executed client-side at user device 108, server-side by server 104, and/or a combination of user device 108 and server 104. Also or alternatively, second speech command can be configured using an API according to the preferences of an administrator and/or an organization of an enterprise computing environment. In other implementations, speech commands include custom commands that correspond to custom action, e.g., customaction(). Custom commands may be commands that are customized by a user of the enterprise computing environment. For example, a user can create a custom command such as “Open SF Muni Logger” that corresponds to a custom action for opening a customized component particularly suited for logging call information regarding a customer concern for SF Muni. In some implementations, custom commands and standard commands can be stored in speech command database 120. In other implementations, custom commands and standard commands might be stored in different tables of the same database.

In FIG. 1, user device 108 may be a computing device capable of communicating via one or more data networks with a server, e.g., server 104. In some implementations, user device 108 can be configured to display a user interface console including one or more components. Examples of user device 108 include a desktop computer or portable electronic device such as a smartphone, a tablet, a laptop, a wearable device, a smart watch, etc. In some implementations, user device 108 can be configured with an audio capturing device such as a microphone. A microphone may be built into the device, e.g. a smartphone microphone, or by wire-based communication, for instance, a stereo input jack or USB (universal serial bus) input connected with user device 108. Also or alternatively, a microphone may communicate with user device 108 using a variety of different wireless communication techniques, for instance, Bluetooth, Wi-Fi, infrared, Near-field communications, etc. User device 108 may send different types of data to server 104.

For example, user device 108 may send audio data 124 to server 104. Also or alternatively, user device 108 can send requests for data and requests to update or change data stored in databases 112, 116, and 120. Additionally, user device 108 may receive data from databases 112, 116, and 120 through server 104. In some implementations, the data received can include presentations of user interface consoles, e.g., updated presentation of user interface console 128.

In some implementations, a combination of the components in system 100 can allow customized components to be triggered, e.g., execute commands, with a user's voice to control a user interface. Upon speaking to the tool, a language processor can parse spoken words into a semantic meaning according to identified keywords. With the identified keywords, server 104 can map the meaning of the identified keywords to either a standard set of API actions or a custom API, and as such standard commands, custom commands, and chained commands can be triggered according to the mapping. Standard commands can be basic user interface functionality that can be driven by a click event. Also or alternatively, commands can be particular to a service and/or application. For example, a chat routing engine for managing customer service concerns through various channels might include commands such as an accept command, a decline command, a preview command, a status command, etc. Custom commands can be developer created actions that are developed for a specific use case of their organization. Chained commands can be a series of commands processed sequentially.

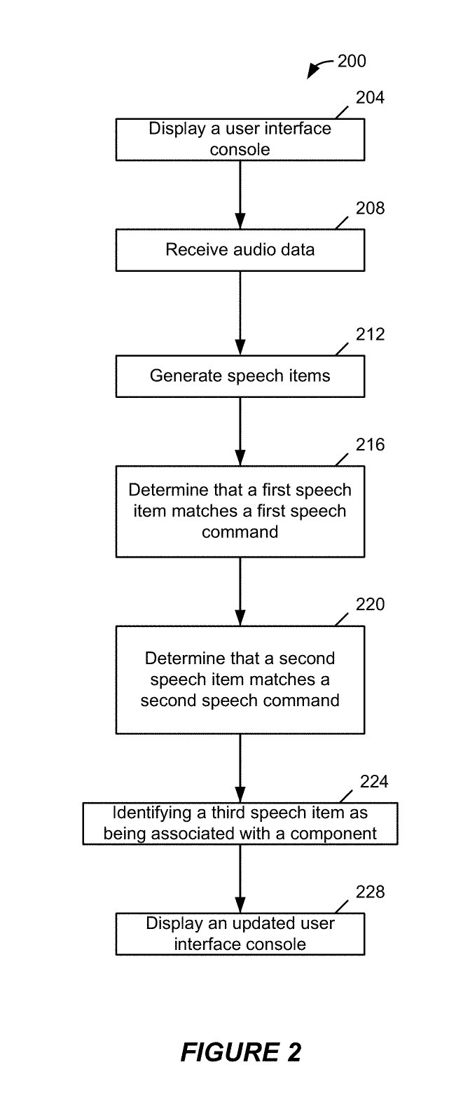

FIG. 2 shows a flow chart of an example of a method 200 for controlling a user interface console using speech recognition, in accordance with some implementations. Method 200 and other methods described herein may be implemented using system 100 of FIG. 1, although the implementations of such methods are not limited to system 100.

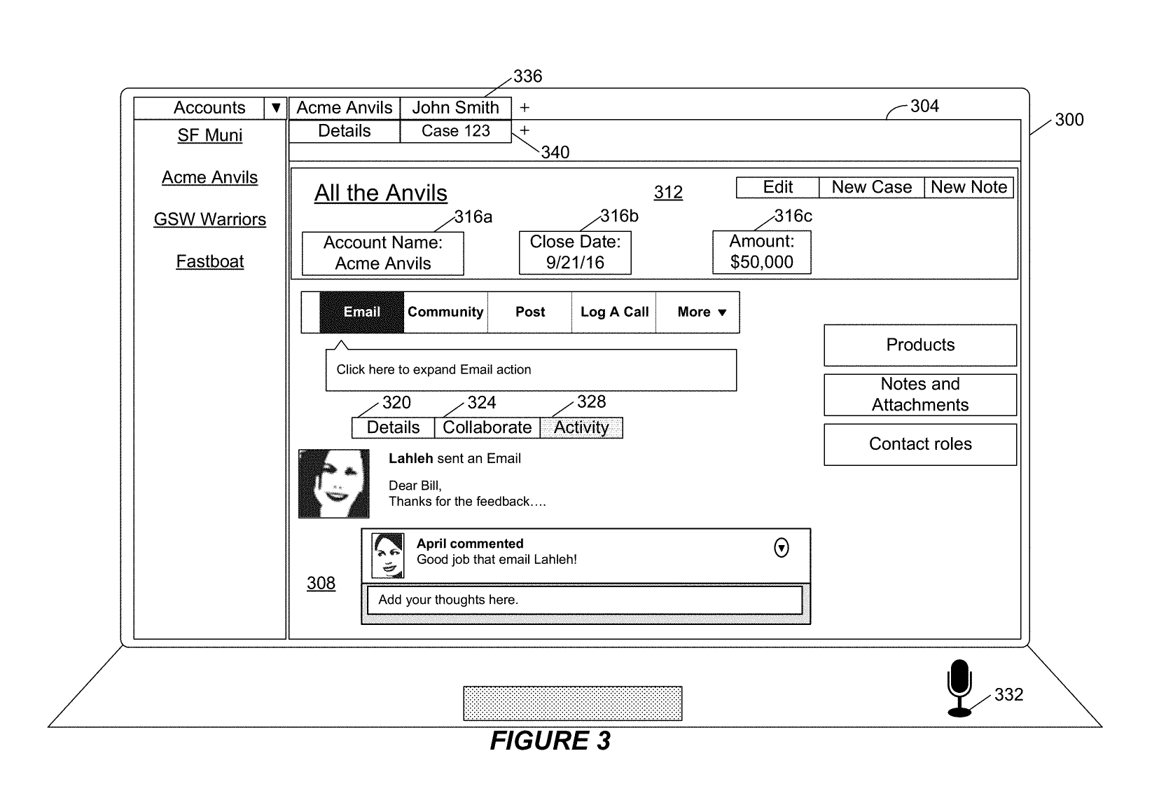

In block 204 of FIG. 2, server 104 of FIG. 1 causes a presentation of a user interface console to be displayed at user device 108. User interface consoles can include components that control information associated with records stored in a database of an enterprise computing environment, e.g., a social network feed receiving a request to add a comment to a feed item. FIG. 3 shows an example of a user interface console 304 displayed on a user device 300, in accordance with some implementations. User interface console 304 includes many displayed components, for instance, a social network feed component 308 and a highlights component 312. In other implementations, user interface console 304 can include a wide variety of combinations of different components, e.g., a notes component, a highlights component, an interaction log component, a primary tab component, a sub tab component, a knowledge article component, a lookup case contact component, a topics component, a milestone component, a case experts component, a social network feed component, a publisher component, a form component, etc. In some implementations, components include fields tailored to a type of functionality particular to a component. For example, highlights component 312 includes data fields 316a-c. Data fields 316a-c of highlights component 312 can provide a high-level overview of an opportunity record, for instance, “All the Anvils.” For example, data field 316a includes a field “Account Name” and a corresponding value of “Acme Anvils;” data field 316b includes a field “Close Date” and a corresponding value of “Sep. 21, 2016;” and data field 316c includes a field “Amount” and a corresponding value of “$50,000.” Consequently, a user viewing this information can quickly review data fields 316a-c to get a high-level overview of the “All the Anvils” opportunity.

In block 208 of FIG. 2, audio data 124 of FIG. 1 is received by server 104. Audio data 124 can be generated at user device 108 based on a user communication received through an audio input device, e.g., an external microphone of a desktop computing device or a built-in microphone of a mobile device. In some implementations, some or all of audio data 124 can be processed and stored locally, e.g., in a cache by user device 108. Also or alternatively, server 104 may filter out noises, e.g., ambient background sound, from the audio data prior to generating speech items.

In the example of FIG. 3, a user speaks into audio input device 332. In some implementations, audio input device 332 is activated to receive user communication when audio input device 332 captures a user issuing an activation command, e.g., “OK console.” In other implementations, audio input device 332 can be activated through hotkey combinations of a keyboard, for instance, a user can press the “Alt” key and the “C” key to activate audio input device 332. In some implementations, a user pressing a hotkey combination can activate audio input device 332 until the same hotkey is pressed again at a later time. Also or alternatively, a user can press and hold the hotkey combination to activate audio input device 332 only during the period of time that the keys remain pressed. In some implementations, when audio input device 332 is activated, a pop-up window, or other visual indication, can be displayed in user interface console 304, which can indicate to the user that audio input device 332 is in an active state. In other implementations, it may be desirable for members of the same team to receive visual indications when another team member is using an audio input device. For example, when audio input device 332 is activated, a visual indication can be displayed on a user interface console of a user that is different from the user speaking into audio input device 332. By way of illustration, Reza is speaking into audio input device 332, which causes a pop-up window to display on Lahleh's user interface console. Even if physically separated, team members can thus become aware of the acts of another team member in near real-time. In some implementations, pop-up windows may only be displayed on another team member's user interface console if the other team member has selected collaborate tab 324. As such, selecting collaborate tab 324 can be an indication that the user is willing to participate in near real-time collaboration. In some implementations, user device 300 can include audio data received as part of past user communications stored in a local speech recognition cache. In some implementations, user device 300 compares the audio data of block 208 of FIG. 2 to another previously received audio data stored in the cache. In some implementations, when audio data does not match any of the previous audio data stored in the local speech recognition cache, user device 300 of FIG. 3 determines that the audio data is not a recognized speech command. Also or alternatively, audio data may include a speech command that is not recognized in the local speech recognition cache; however, it might be recognized at a server running in the enterprise computing environment. As such, the speech command can be sent to the server for further analysis.

In block 212 of FIG. 2, server 104 of FIG. 1 generates speech items based on the audio data received in block 208. In some implementations, prior to generating speech items, audio data 124 is converted to unstructured text and speech items are generated based on the unstructured text.

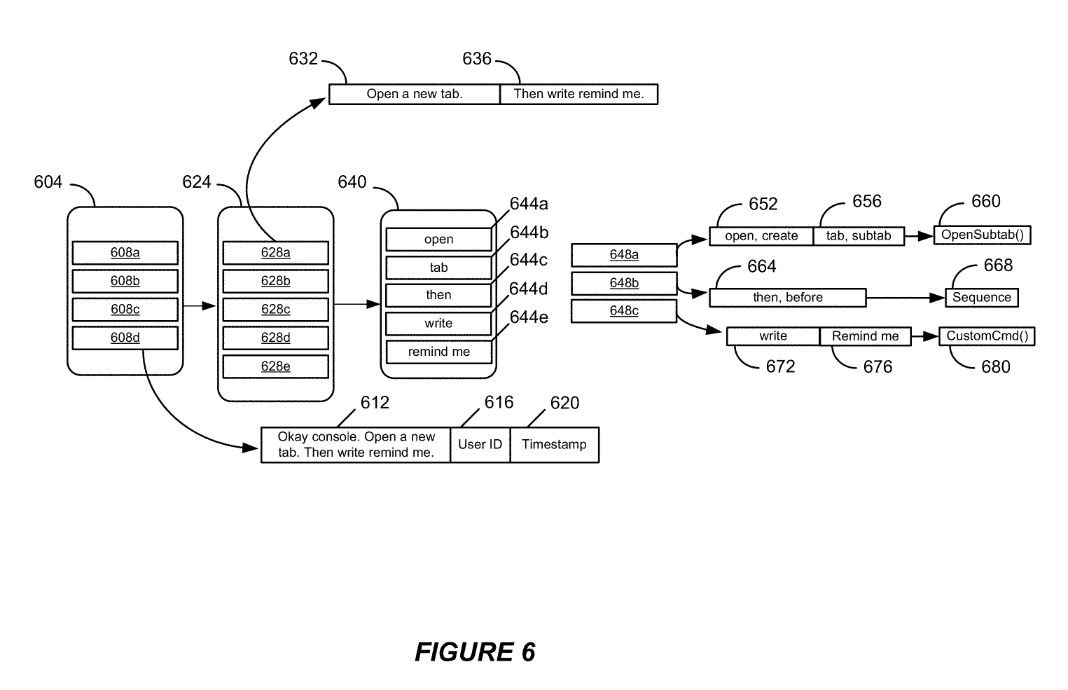

For example, FIG. 6 shows an example of generating speech commands based on audio data, in accordance with some implementations. In FIG. 6, audio data queue 604 includes audio data 608a-608d. Audio data queue 604 can include audio data from different users of an enterprise computing environment. For example, audio data 608a and 608b can be from User 1, whereas audio data 608c and 608d can be from User 2. Audio data can include a representation of a user communication, e.g., unstructured text 612, a user identifier, e.g., user identifier 616, and a timestamp, e.g., timestamp 620. In some implementations, a server of an enterprise computing environment receives audio data 608a-608d in the order that they are generated at a particular user device and can be handled according to a timestamp, e.g., timestamp 620. Similarly, the server can process audio data 608a-608d in the order received. As such, the manner of processing audio data 608a-608d can be implemented in such a way to avoid creating conflicts from changes to data made after the audio data is processed. As mentioned above, server 104 of FIG. 1 can convert audio data to unstructured text, e.g. unstructured text 612 and start logically separating and organizing the unstructured text into smaller parts. For example, server 104 of FIG. 1 parses the unstructured text using a semantic parser to map formal representations of words to corresponding parts of the unstructured text, for instance, sentences, subjects, objects, nouns, verbs, etc. Parsed audio data from audio data queue 604 of

FIG. 6 can be stored as part of a separate queue, e.g., parsed audio data queue 624. Parsed audio data queue can include parsed audio data 628a-628e. In one example, parsed audio data queue 624 can include speech phrases 632 and 636. In some implementations, parsed audio data queue 624 can be a queue particular to a single user that is maintained according to user identifier 616. In other implementations, parsed audio data queue 624 can be a queue similar to audio data queue 604 that includes parsed audio data from different users of the enterprise computing environment. In still other implementations, parsed audio data 628a-628e is parsed at different levels of semantic abstraction. For example, unstructured text 612 can be parsed starting with a string in its entirety, e.g., “Okay Console. Open a new tab. Then write remind me.” Parsed audio data 628a can include speech phrases 632 and 636 as representations of separate complete sentences, e.g., “Open a new tab.” and “Then write remind me.” Separation of text into increasingly smaller parts can improve processing efficiency of larger amounts of audio data. As such, after parsing audio data 628a, speech items 644a-644a are generated and stored as part of speech items queue 640. In one example of speech items being generated based on audio data, the processed audio data 608d can result in speech items 644a-644a. For example, a user communication of “Okay console. Open a new tab. Then write remind me” can result in the following speech items “open,” “tab,” “then,” “write,” and “remind me.” In this example, some text of phrases 632 and 636 are excluded from classification as speech items, e.g., “a,” white space, and punctuation.

In block 216 of FIG. 2, server 104 of FIG. 1 determines that a first speech item matches a first speech command. In some implementations, speech commands are maintained as part of one or more databases in an enterprise computing environment, e.g., speech command database 120. Speech commands can represent automatic server-based interactions with the user interface consoles, e.g., opening an e-mail component, updating and/or changing information in a record. In some implementations, a speech command is an API request, for instance, a request to close a tab, e.g., primary tab 336 or sub tab 340. Other examples of speech commands include custom commands (discussed further below), a macro command, a chain, a post command, an attach command, a remind command, a write command, an open command, a select command, an edit command, a create command, a delete command, a refresh command, a get command, a send command, a fire command, an accept chat command, a decline command, a log command, a search command, a subscribe command, an e-mail command, a convert command, an escalate command, a share command, an archive command, a comment command, and a like command. Speech commands are not limited to the above-mentioned examples and can include other speech commands for interacting with a user interface console. Also or alternatively, speech commands can be added to speech command database 120 of FIG. 1 based on accessibility data for assisting visually impaired users. For example, each component might include accessibility data that is specific to interacting with that component, e.g., read-aloud text descriptions, navigation commands, etc. As such, speech recognition incorporating component-based speech commands can assist some users who would otherwise be unable to interact with a user interface console. In another implementation, a user might wish to have a command executed after a particular amount of time, e.g., a delay command. For example, a user might say, “Close record XYZ in 10 minutes.” As such, speech commands can be incorporated into various customer service tasks where delay might occur.

In some implementations, speech commands can be a specific type of command for a particular type of component. In other words, some speech commands may only be relevant for certain interactions with a component. For example, the speech commands of a like command or a comment command may only be used for controlling a social network feed component. In another example, an accept chat command may only be used for interacting with a computer-telephony integration component. In other implementations, speech commands can also be used with different types of components. For example, an edit command may be used to edit a field of a highlights component, and the edit command may also be used to edit a comment that has been added to a feed item of a social network feed component.

In some implementations speech items, e.g., “Open,” are matched with speech commands, e.g., an open command. Matching of speech items with speech commands might be accomplished in a variety of ways. For example, an administrator and/or server can generate a list of speech items mapped with speech commands. As one example of a list of speech items mapped with commands, one column of speech items can include open tab, close tab, and select tab. A second column matching the order of the first column can include an open command, a close command, and a select command. In other implementations, matching speech items to speech commands includes combinations of matching algorithms and matching criteria. For example, a matching cache of previously matched speech items to speech commands can be an indication that an incoming speech, e.g., “attach a file to post 2” item should be matched with a particular speech command, e.g., the cache includes “attach a file to post 1” matched an attach command that can attach and/or associate a file to a feed item. In other implementations, the matching cache can also include the previously matched speech items of team members of the user. For example, the matching cache might include a previously matched speech item from Reza, e.g., “Change account name to Acme Anvils” matched an edit command to data field 316a of FIG. 3. As such, when audio data from Lahleh, a member of Reza's team, is processed, speech items of “Change amount to fifty thousand dollars” might quickly be matched with an edit command to data field 316c. Other criteria can include metadata analyzed as part of the audio data processed in block 208 of FIG. 2. Examples include how recently a particular component was accessed, e.g., Reza recently selected the “Email” tab of the publisher component; a location of the mouse cursor, e.g., scrolling adjusted coordinates of a cursor; whether one of the speech items has not been previously received by server 104 of FIG. 1; which components are currently visible in the user interface console, e.g., social network feed component 308 of FIG. 3 and highlights component 312; etc. Returning to the example of FIG. 6, speech item 644a can match speech command 660. Also or alternatively, a combination of speech item category 652 and component 656 matches speech command 660. In some implementations, machine learning, e.g., artificial neural networking techniques, can facilitate matching of speech items to speech commands. For example, as more speech items are processed in the enterprise computing environment, logs of successfully matched and unsuccessfully matched speech items to speech commands can be maintained. Consequently, these logs can be used to create semantic categories, e.g., speech item categories 652, 664, and 672, which expand the vocabulary of possible speech items that may be used to match a speech command. In FIG. 6, speech item category 652 includes speech items for “open” and “create,” which the enterprise computing environment could process as similar terms, e.g., synonymous. As such, speech item 644a might be “open” or “create,” either of which might be deemed a match by the enterprise computing environment. Similarly, speech item category 664 includes speech items “then” and “before.” The category in this example could facilitate the order in which speech commands are processed, e.g., a first speech command is executed “then” a second speech command is executed Likewise, the speech item “then” could be treated similarly as a first speech command being executed “before” a second speech command. In other implementations, speech item categories can also be used for identifying components, e.g., a speech item category for components. As discussed above, speech item categories can be generated and/or updated automatically using machine learning techniques. In addition and in some implementations, a matching threshold can be defined by server 104 of FIG. 1 in order to determine whether a speech item meets a matching threshold such that it is deemed to have matched a speech command. For example, if a speech item includes “opens,” server 104 might determine that “opens” is similar enough to “open,” e.g., within the matching threshold, that server 104 matches the speech item to an open speech command.

In block 220 of FIG. 2, server 104 of FIG. 1 determines that a second speech item matches a second speech command. In some implementations, the speech command of block 220 of FIG. 2 is customized by a user of an enterprise computing system. In some implementations, a custom speech command might be a customized version of a standard speech command, for instance, a write command that has been modified to include additional functionality beyond just inputting text, e.g., including the audio data for generating the text, additional formatting, inputting text to a custom component, etc. In other implementations, a custom speech command might be a command that is not based on a standard speech command. In other words, a speech command may be specifically tailored to an organization's particular configuration of their user interface console. When a custom speech command is created by a user, a corresponding speech item category can also be created. As discussed above, speech item categories can be the terms used by server 104 of FIG. 1 to identify speech items and match them to custom commands. In the example of FIG. 6, custom speech item category 672 includes a custom speech item of “write.” In some implementations, other speech items can be included that have a similar meaning to “write.” For example, custom speech items in speech item category 672 might also include “type,” “input,” “jot,” etc. In some implementations, machine learning algorithms can be used to create suggested speech items for inclusion in speech item category 672. For example, when a user enters an initial speech item, the user might select a button to receive a list of synonyms that could be useful alternative terms to include with the initial speech item.

In some implementations, a speech command can be a macro command. In some implementations, a macro command represents a sequence of automated selections, e.g., a sequence of automated keystrokes and/or mouse clicks. Macro commands can include sequences of commands that are iterated automatically by a computing device. Macros can be created to replace repetitive tasks that are carried out using many keystrokes and/or mouse clicks from a user, e.g., selecting an email template, sending an email to a customer, updating a case status, etc. For example, a macro can be configured to input text to the subject line of an email and update a case status accordingly. In other words, a macro can be a set of instructions, performed by a server and/or a client device to automate a task. As such, a macro can save time and add consistency to a user's work. In some implementations, a macro command includes bulk action functionality. As such, a command can be used to update multiple records in a database. For example, a user may say, “Update the status of all opportunities associated with the SF Muni account to closed.” Consequently, a macro command can iterate the same series of keystrokes to change each status of an opportunity record to closed.

In block 224 of FIG. 2, server 104 of FIG. 1 identifies a third speech item as being associated with a component. A component can be identified according to a component identifier, for instance, social network feed component 308 of FIG. 3 can have a first component identifier and highlights component 312 can have a different component identifier. In some implementations, the component identified in block 224 of FIG. 2 is a component that is user-customized. As discussed further above, components can display different views of record data. Custom components can be positioned in different regions of the user interface console, for instance, a footer, a sidebar, within another component, e.g., highlights panel, etc. Components may be created using a combination of one or more component based frameworks, canvas applications, lookup fields, related lists, or report charts. In addition, integration toolkits can be used to build components through one or more JavaScript APIs that let developers extend or integrate a console. As such, an integration toolkit can provide a user with programmatic access, for instance, open and close tabs or integrate a console with external applications. Also or alternatively, a component can be positioned among a hierarchical structure of other components, e.g., one component may have one or more “child” and/or “parent” components. For example, a primary tab in a user interface console may be the parent of one or more sub tabs. In a hierarchical structure of tabs, a parent tab may be thought of as containing each of its children. In the example of FIG. 3, primary tab 336 can include sub tab 340.

In some implementations, a server “chains” commands based on voice data, e.g., server 104 of FIG. 1 executes a sequence of commands based on a single user communication. For example, a user might say, “open a new opportunity, then add an opportunity name: ‘All the Anvils.’” As such, server 104 of FIG. 1 might process the user communication by chaining a command to create an opportunity record followed by a command to modify the opportunity name field to include “All the Anvils.” In some implementations, more than two commands can be chained by server 104. Returning to the example above, a third command can be executed by server 104 to modify the amount field to include “$50,000.” In another example seen in FIG. 6, speech item queue 640 includes speech items 644a-e for “open,” “tab,” “then,” “write,” and “remind me.” Sequence 688 can be used to identify the order in which commands are chained. In this example, speech item 644d represents a speech item that can be identified as a chained command. Chained commands can be used by server 104 of FIG. 1 to determine the chaining order that speech items might be executed. In this example, a command to open a tab can be executed first followed by a second command to write remind me in that new tab. The position of the chain command does not necessarily indicate the order in which speech commands might be executed by server 104. For example, if there were speech items for the user communication “Before writing remind me, open a new tab,” “before” can be identified as a chain command that indicates a command to open a tab should be executed before a command to write remind me. In some implementations, chaining of commands can be implemented using one or more call back functions. For example, the command to be executed second in the sequence can be the nested command within the callback function, e.g., s.force.openTab(writenote()).

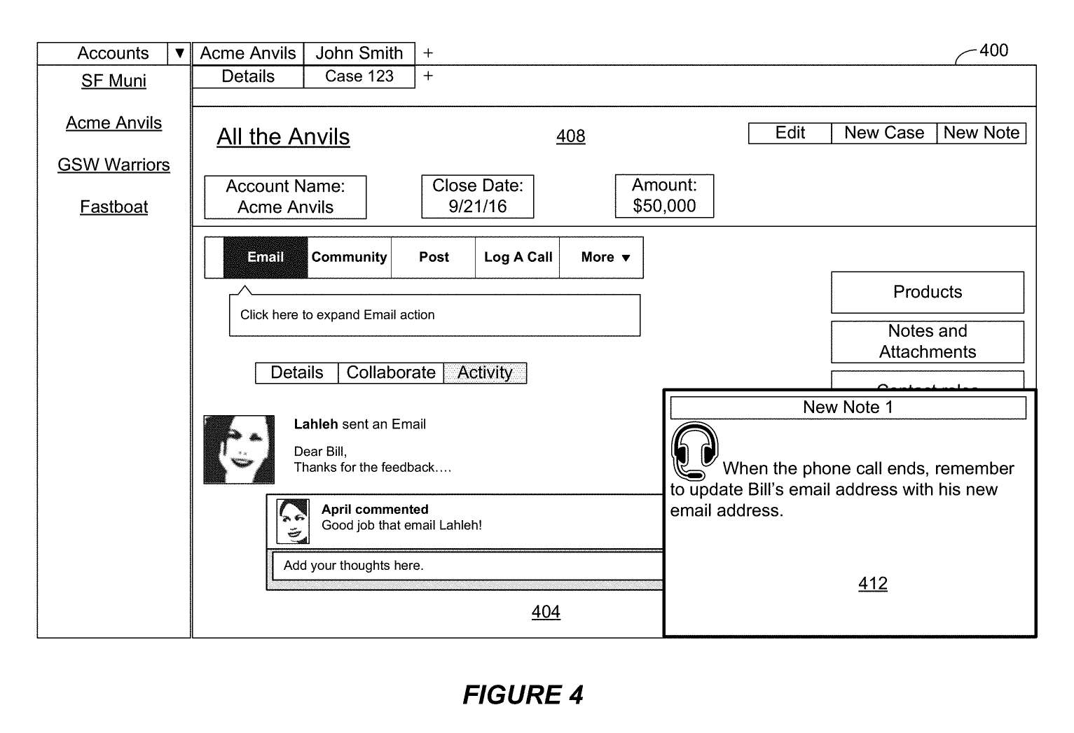

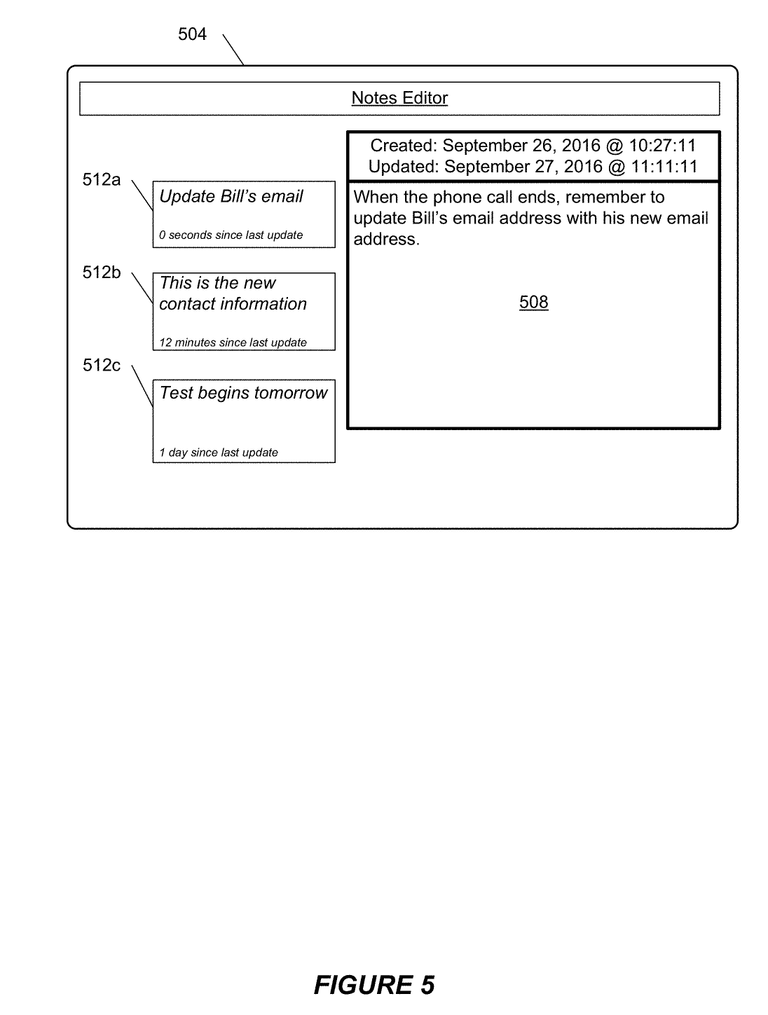

In block 228 of FIG. 2, server 104 of FIG. 1 provides an updated presentation of user interface console 128 to user device 108. In some implementations, the updated presentation is displayed according to the speech commands identified in blocks 216 and 220 of FIG. 2. For example, after a server executes blocks 204-224, user interface 400 of FIG. 4 is one example of an updated presentation. As such, an updated presentation can be displayed without user input generated from a pointing device, e.g., a mouse, touchpad, finger on a touchscreen, stylus, trackball, or other pointing device known to one skilled in the art. In FIG. 4, notes component 412 is displayed as a pop-up window over social network feed component 404. Notes component 412 includes text, e.g., “When the phone call ends, remember to update Bill's email address with his new email address.” In other implementations, notes component 412 can also include other content such as the audio data used to generate the text. Other content that might be displayed in notes component 412 can include images, video, etc. Updated presentations are not limited to displaying a new component over existing components. For example, in response to executing a speech command to open a new primary tab, e.g., primary tab 336 of FIG. 3, an updated presentation can include a new set of displayed components displayed within a pane of a new primary tab. In another example, FIG. 5 shows an example of a component displayed on a computing device, in accordance with some implementations. In the example of FIG. 5, a notes component 504 can be displayed based on one or more speech commands to open the notes component. Notes component 504 can include a word processing form 508 and notes 512a-512c. A user can interact with word processing form 508 to compose, edit, or format text previously generated using speech recognition, as discussed further above. After generating some text using speech recognition techniques, a user might add text or edit text with word processing form 508 using a keyboard and mouse. Notes 512a-512c can be part of a list of notes created by a user. Note 512a might be a note that the user is currently viewing on word processing form 508. Note 512a can include a title of “Update Bill's email” and metadata indicating that it has been “0 seconds since last update.” In some implementations, the title of note 512a can be a summary of the content in note 512a. The summary can be automatically generated using machine learning techniques to extract and/or abstract keywords and meaning from the contents. For example, a server can analyze the contents of a note, identify keywords in the contents, extract the keywords, identifying the meaning according to the keywords, and arrange the keywords according to an understandable identified meaning, e.g., “Update Bill's email,” “This is new contact information,” or “Test begins tomorrow.” In addition, notes 512b and 512c can function similarly to note 512a, and a user can select either note 512b or 512c to display the contents in word processing form 508.

Systems, apparatus, and methods are described below for implementing database systems and enterprise level social and business information networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed. By way of example, a user can update a record in the form of a CRM record, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed to the manager's feed page or other page.

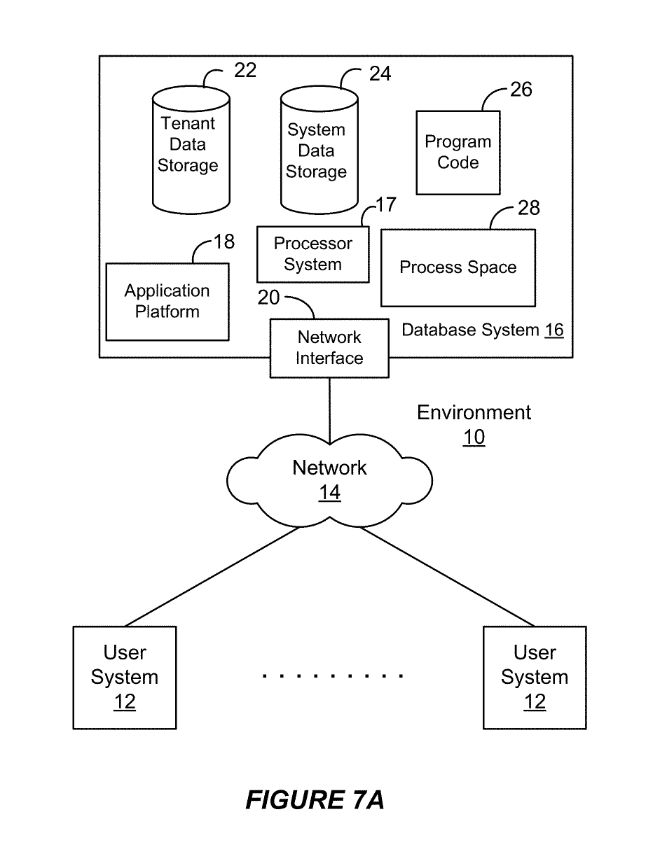

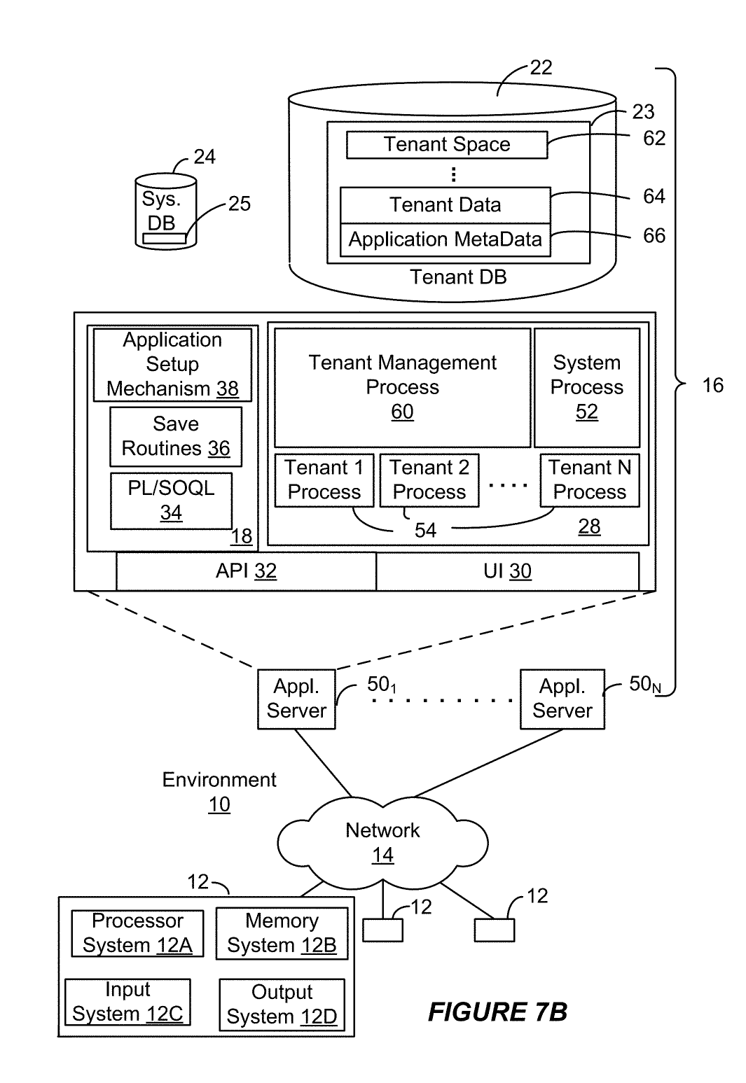

FIG. 7A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above. A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 7A (and in more detail in FIG. 7B) user systems 12 might interact via a network 14 with an on-demand database service, which is implemented in the example of FIG. 7A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 7A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 7A and 7B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 7A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or other hardware processor. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 7B shows a block diagram of an example of some implementations of elements of FIG. 7A and various possible interconnections between these elements. That is, FIG. 7B also illustrates environment 10. However, in FIG. 7B elements of system 16 and various interconnections in some implementations are further illustrated. FIG. 7B shows that user system 12 may include processor system 12A, memory system 12B, input system 12C, and output system 12D. FIG. 7B shows network 14 and system 16. FIG. 7B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above. User system 12, network 14, system 16, tenant data storage 22, and system data storage 24 were discussed above in FIG. 7A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 7B, system 16 may include a network interface 20 (of FIG. 7A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases. Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database. Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

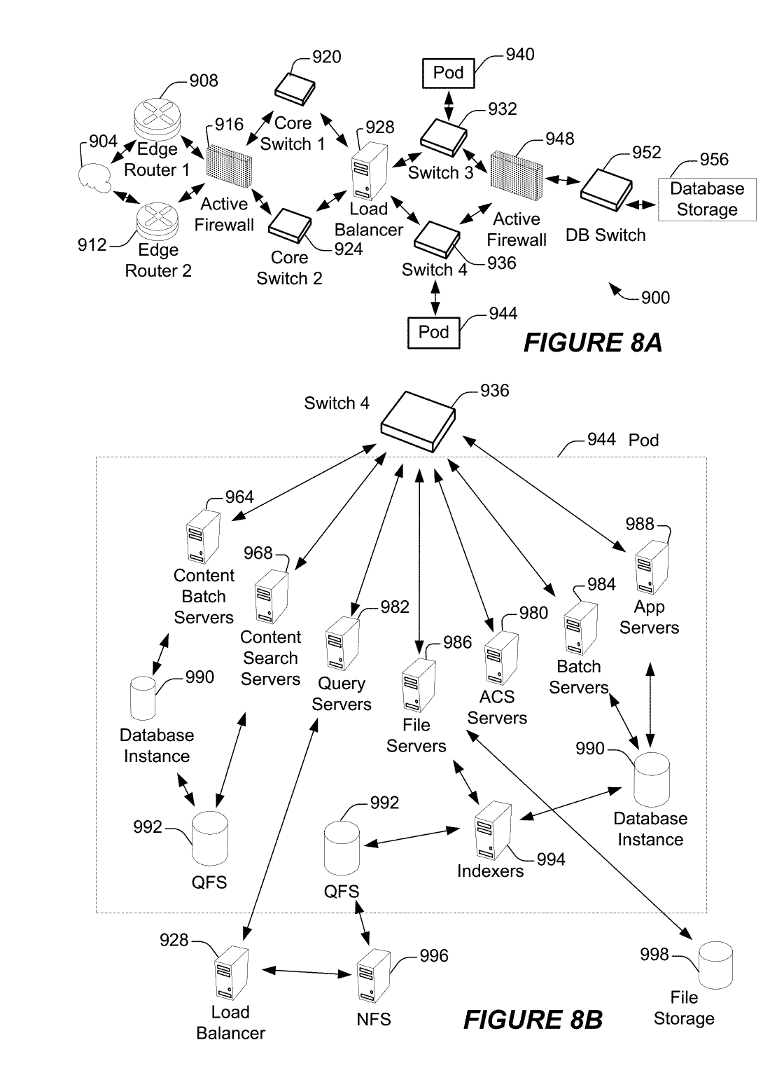

FIG. 8A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 8A and 8B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 8A and 8B, some implementations of an on-demand database service environment may include anywhere from one to many devices of each type. Also, the on-demand database service environment need not include each device shown in FIGS. 8A and 8B, or may include additional devices not shown in FIGS. 8A and 8B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 8B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 8A and 8B.

FIG. 8B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, California. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

Some but not all of the techniques described or referenced herein are implemented as part of or in conjunction with a social networking database system, also referred to herein as a social networking system or as a social network. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, CRM services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, LinkedIn®, Twitter®, Google+®, Yammer® and Jive® by way of example only.

Some social networking systems can be implemented in various settings, including organizations. For instance, a social networking system can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail herein.

In some social networking systems, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a GUI on a display device such as the display of a computing device as described herein. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail herein, allows a user to track the progress of that record when the user is subscribed to the record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be social media messages submitted by a user or can otherwise be generated in response to user actions or in response to events. Examples of social media messages include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a news feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned herein, the data can include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) generally refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different types of social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a social media message, such as a user-generated post of text data, and a feed tracked update to a record or profile, such as a change to a field of the record. Feed tracked updates are described in greater detail herein. A feed can be a combination of social media messages and feed tracked updates. Social media messages include text created by a user, and may include other data as well. Examples of social media messages include posts, user status updates, and comments. Social media messages can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a GUI, for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Social media messages and other types of feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and social media messages, such as posts, comments, likes, etc., can define group conversations and change over time.

An “entity feed” or “record feed” generally refers to a feed of feed items about a particular record in the database. Such feed items can include feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system comprising:
a database system implemented using a server system, the database system configurable to cause:
maintaining a plurality of user interface consoles and a plurality of speech commands, the speech commands representing automatic server-based interactions with the user interface consoles;
displaying a presentation of a first one of the user interface consoles on a display of a user device, the presentation of the first user interface console comprising a plurality of components capable of controlling information associated with at least one record stored in a database of the database system;
processing audio data received from the user device, the audio data indicating a user communication regarding the first user interface console, the processing comprising:
generating a plurality of speech items based on the audio data,
determining that a first one of the speech items matches a first one of the speech commands,
determining that a second one of the speech items matches a second one of the speech commands, the second speech command being customized by a user, and
responsive to determining that the second speech item matches the second speech command, identifying a third one of the speech items as being associated with a user-customized component; and
displaying, based on the first speech command and the second speech command, an updated presentation of the first user interface console comprising the user-customized component.

2. The system of claim 1, wherein the second speech command is configured using an application programming interface, the speech command being associated with by an organization of the database system.

3. The system of claim 1, wherein the first speech command is a macro representing a sequence of automated selections.

4. The system of claim 1, wherein the updated presentation of the first user interface console is displayed irrespective of user input generated via a pointing device.

5. The system of claim 1, wherein displaying the updated presentation comprises:
determining that a fourth one of the speech items matches a chain command, the chain command representing an execution sequence for the first speech command and the second speech command.

6. The system of claim 1, wherein generating the plurality of speech items based on the audio data comprises:
generating or updating a first data object based on the audio data, the first data object representing unstructured text;
parsing, using an artificial neural network associated with the database system, the first data object to identify the speech items; and
storing the identified speech items using a second data object representing speech recognition data in the database of the database system.

7. The system of claim 1, wherein the speech commands comprise one or more of: a custom command, a macro command, a chain command, a post command, an attach command, a remind command, a write command, an open command, a select command, an edit command, a create command, a delete command, a refresh command, a get command, a send command, a fire command, an accept chat command, a decline command, a log command, a search command, a subscribe command, an e-mail command, a convert command, an escalate command, a share command, an archive command, a comment command, or a like command.

8. A method comprising:
maintaining a plurality of user interface consoles and a plurality of speech commands, the speech commands representing automatic server-based interactions with the user interface consoles;
causing display of a presentation of a first one of the user interface consoles on a display of a user device, the presentation of the first user interface console comprising a plurality of components capable of controlling information associated with at least one record stored in a database of a database system;
receiving audio data from the user device, the audio data indicating a user communication regarding the first user interface console;
processing the received audio data, the processing comprising:
generating a plurality of speech items based on the audio data,
determining that a first one of the speech items matches a first one of the speech commands,
determining that a second one of the speech items matches a second one of the speech commands, the second speech command being customized by a user, and
responsive to determining that the second speech item matches the second speech command, identifying a third one of the speech items as being associated with a user-customized component; and
causing, based on the first speech command and the second speech command, display of an updated presentation of the first user interface console comprising the user-customized component.

9. The method of claim 8, wherein the second speech command is configured using an application programming interface, the speech command being associated with by an organization of the database system.

10. The method of claim 8, wherein the first speech command is a macro representing a sequence of automated selections.

11. The method of claim 8, wherein the updated presentation of the first user interface console is displayed irrespective of user input generated via a pointing device.

12. The method of claim 8, wherein causing display of the updated presentation comprises:
determining that a fourth one of the speech items matches a chain command, the chain command representing an execution sequence for the first speech command and the second speech command.

13. The method of claim 8, wherein generating the plurality of speech items based on the audio data comprises:
generating or updating a first data object based on the audio data, the first data object representing unstructured text;
parsing, using an artificial neural network associated with the database system, the first data object to identify the speech items; and
storing the identified speech items using a second data object representing speech recognition data in the database of the database system.

14. The method of claim 8, wherein the speech commands comprise one or more of: a custom command, a macro command, a chain command, a post command, an attach command, a remind command, a write command, an open command, a select command, an edit command, a create command, a delete command, a refresh command, a get command, a send command, a fire command, an accept chat command, a decline command, a log command, a search command, a subscribe command, an e-mail command, a convert command, an escalate command, a share command, an archive command, a comment command, or a like command.

15. The method of claim 8, wherein the components comprise one or more of: a notes component, a highlights component, an interaction log component, a primary tab component, a subtab component, a knowledge article component, a lookup case contact component, a topics component, a milestone component, a case experts component, a social network feed component, a publisher component, or a form component.

16. A computer program product comprising computer-readable program code to be executed by one or more processors when retrieved from a non-transitory computer-readable medium, the program code comprising instructions configurable to cause:
maintaining a plurality of user interface consoles and a plurality of speech commands, the speech commands representing automatic server-based interactions with the user interface consoles;
displaying a presentation of a first one of the user interface consoles on a display of a user device, the presentation of the first user interface console comprising a plurality of components capable of controlling information associated with at least one record stored in a database of a database system;
processing audio data received from the user device, the audio data indicating a user communication regarding the first user interface console, the processing comprising:
generating a plurality of speech items based on the audio data,
determining that a first one of the speech items matches a first one of the speech commands,
determining that a second one of the speech items matches a second one of the speech commands, the second speech command being customized by a user, and
responsive to determining that the second speech item matches the second speech command, identifying a third one of the speech items as being associated with a user-customized component; and
displaying, based on the first speech command and the second speech command, an updated presentation of the first user interface console comprising the user-customized component.

17. The computer program product of claim 16, wherein the second speech command is configured using an application programming interface, the speech command being associated with by an organization of the database system.

18. The computer program product of claim 16, wherein the first speech command is a macro representing a sequence of automated selections.

19. The computer program product of claim 16, wherein the updated presentation of the first user interface console is displayed irrespective of user input generated via a pointing device.

20. The computer program product of claim 16, wherein displaying the updated presentation comprises:
determining that a fourth one of the speech items matches a chain command, the chain command representing an execution sequence for the first speech command and the second speech command.
